(19) United States
(12) Patent Application Publication
(10) Pub. No.: US 2022/0227643 A1
(43) Pub. Date: Jul. 21, 2022

(54) Method and Apparatus to Reduce Wastewater Greenhouse Gas Emissions, Nitrogen and Phosphorous Without Bioreactor Processing

(71) Applicant: Marcus G. Theodore, Salt Lake City, UT (US)

(72) Inventor: Marcus G. Theodore, Salt Lake City, UT (US)

(73) Assignee: Earth Renaissance Technologies, LLC, Salt Lake City, UT (US)

(21) Appl. No.: 17/713,864

(22) Filed: Apr. 5, 2022

Related U.S. Application Data
(63) Continuation-in-part of application No. 16/412,302, filed on May 14, 2019.

(51) Int. Cl. C02F 1/52; C02F 1/32

(52) U.S. Cl. CPC C02F 1/5236; C02F 2101/20; C02F 1/32

(57) ABSTRACT

This invention relates to a treatment method and apparatus directed to improving water quality, increasing net energy production, and reducing greenhouse gas emissions without employing bioreactor processing for waters containing suspended organic solids, PPCPs, PFAS, negative colloids, heavy metals, phosphates, nitrates, carbonates, silicates, chlorides and sodium ions. It employs SO₂, sulfites and bisulfites to self-agglomerate suspended organic solids with sorbed PFAS and PPCPs, and acid leach heavy metals into solution. Subsequent liming filtration separates of metal hydroxides and insoluble calcium salts while chemically conditioning the separated organic solids for gasification or burning. The second filtrate is then exposed to ultra violet light for pathogen disinfection, and exciting sulfites to remove nitrates, and degrade PFAS and PPCPs to form a disinfected metal free salt balanced reclaimed wastewater with reduced PFAS, PPCPs, pathogens and negligible nitrogen and phosphorous.

### RELATED APPLICATIONS

This application is a continuation-in-part application of utility patent application Ser. No. 16/412,302, filed May 14, 2019, entitled “Method and Apparatus to increase wastewater bioreactor processing capacity while reducing greenhouse gas emissions”

### BACKGROUND OF THE INVENTION

### Field

This invention relates to wastewater treatment methods to reduce greenhouse gas emissions. More particularly, it relates to a treatment method and apparatus, which is directed to improving wastewater water quality, increasing net energy production, and reducing greenhouse gas emissions without employing bioreactor processing.

### State of the Art

Most large municipal systems employ a series of settling ponds sequentially concentrating the solids contained in wastewater either with or without polymers for separation from liquids via mechanical separation means, such as belt presses. To produce a clean effluent that can be safely discharged to watercourses, wastewater treatment operations use distinct stages of bioreactor treatment to remove harmful contaminants. Preliminary wastewater treatment usually involves gravity sedimentation of screened wastewater to remove settled solids. Secondary wastewater treatment is accomplished through a biological process, removing biodegradable material. This treatment process uses microorganisms to consume dissolved and suspended organic matter, producing carbon dioxide and other by-products. The removal capacity of these secondary bioreactors is dependent upon the influent suspended solids and dissolved solids and nutrient concentration loads placed on them. Tertiary or advanced treatment is used when extremely high-quality effluent is required with reduced solid residuals collected through tertiary treatment consisting mainly of chemicals added to clean the final effluent, which are reclaimed before discharge, and therefore not incorporated into bio-solids.

Wastewater treatment plants employ different types of bioreactors using microbes and bacteria to reduce bio solids, BOD, nitrogen and phosphorous compounds contained in wastewater influent. These plants produce 2% of all the non-biogenic greenhouse gas emissions in the U.S., see “What are the worst greenhouse gases and why?”, Oct. 31, 2018, www.answers.com/Q/What_are_the_worst_greenhouse_gas . . . . Globally, wastewater treatment plants generate 3% of all the non-biogenic greenhouse gas emissions; see Sewage Plants Overlooked Source of CO2 by Bobby Magill, Climate Central dated Oct. 8, 2018, www.climatecentral.org/news/sewageplants-overlooked-co2. The source of these greenhouse gas emissions from a wastewater treatment plant are:

Sludge reuse 37%

Anaerobic Digestion 35%

Biomass Decay 6%

BOD removal 5%

Nitrogen Removal 5%

Nitrous Oxide Removal 1%, and

Energy Consumption from coal and natural gas 11%.

Non-biogenic greenhouse gas emissions are defined as those emissions from natural fermentative biological processes, which are not counted, so only the Energy Consumption Segment greenhouse gases of 11% are counted from coal, wood, and natural gas consumption. Thus the largest emissions from sludge reuse of 37% for land application and 35% for anaerobic digestion are ignored as biogenic. If included, the actual carbon dioxide emissions from wastewater treatment operations are 9 times the 3% non-biogenic emissions or 27%.

Of the greenhouse gas emissions produced by microbes and bacterial, carbon dioxide is the most prevalent emitted greenhouse gas and can be somewhat reduced. Methane is produced in a lesser amount, but is 31 times more effective in trapping heat in the atmosphere than CO₂ and can be reduced. Another greenhouse gas emitted by wastewater treatment plant microbes and bacteria is nitrous oxide. Nitrous oxide is 310 time more effective in trapping heat than CO₂ and can be reduced.

Anaerobic digestion is used to reduce the sludge disposal volume generated by a wastewater treatment plant 40 to 50%. It generates low BTU biogas releasing methane and CO2, gases when not recaptured. 1200 wastewater treatment plants in the US still use anaerobic digestion, and only half of these capture the released biogas.

Anaerobic digestion is a slow biological process requiring a large footprint, is energy and capital intensive, and difficult to control environmental conditions for digestion. It also still requires landfilling the balance of the sludge not reduced.

Land application sludge reuse is used for aerobic decomposition of the sludge producing carbon dioxide gas, hydrogen sulfide gas, SOx, NOx, and water. Although it is not as susceptible to environmental conditions as anaerobic digestion, it requires solids drying to reduce disposal volume. It also has a long decomposition time measured in years tying up land used for disposal. It also generates undesirable odors, and produces more sludge than anaerobic processes, requiring a larger landfill footprint; see “Introduction in the technical design for anaerobic treatment systems” by Dipl-Ing. Heinz-Peter Mang, pp. 7-10.

Both anaerobic digestion and land application of sludge release into the environment sorbed heavy metals, pathogens, pharmaceuticals, personal care products, and hazardous prions on the sludge substrate. Sludge substrate decomposition also releases significant amounts of methane into the air.

To ensure that bio solids applied to the land do not threaten public health, the U.S. Environmental Protection Agency (EPA) requires compliance with 40 CFR Part 503 Rules categorizing bio solids as Class A or B, depending on the levels of pathogenic organisms in the material, and describes specific processes to reduce pathogens to these levels.

The 503 rule also requires heavy metals reduction and “vector attraction reduction” (VAR)—reducing the potential for spreading of infectious disease agents by vectors (i.e., flies, rodents and birds)—and spells out specific management practices, monitoring frequencies, record keeping and reporting requirements. Incineration of biosolids is also covered in the regulation.

These conventional Class A Biosolids treatment methods are generally energy intensive to achieve rapid disinfection, or take a long time for biodegradation.

In addition, chemically advanced removal technology to reduce phosphorous and nitrogen in effluent discharge have evolved using UV energized sulfites for removal of nitrogen, phosphorus, PFAS, and heavy metal treatment for precipitation and removal have evolved eliminating the need for biological wastewater treatment, which further reduces greenhouse gas emissions; see “Nitrate Reduction by the Ultraviolet-Sulfite Advanced Reduction Process” by Vellanki et al, Environmental Engineering Science Vol. 38, No. 10, published online: 12 Oct. 2021, doii.org/10.1089/ees2021.0054; “Phosphorous removal from wastewater” Lenntech, www.lenntech.com/phosphorous-removal.htm, Copyright © 1998-2022 Lenntech B.V. All rights reserved; and “Degradation and Removal Methods for Perfluoroalkyl and Polyfluoroalkyl Substances in Water” by Merino et al, page 639, ARPs: dithionite and sulfite, Environmental Engineering Science, Vol. 33, Nov. 9, 2016.

The chemical treatment method described below provides a low energy treatment method rapidly dewatering sludge for energy production, reducing heavy metals, PFAS, PPCP, hazardous prions and pathogens to improve water quality while reducing greenhouse gas emissions.

### SUMMARY OF THE INVENTION

The present method and apparatus is a water treatment method for any waters, such as irrigation waters, contaminated waters, conventional wastewater influent, and/or wastewater treatment plant process liquid streams containing suspended organic solids PPCPs, PFAS, negative colloids, heavy metals, phosphates, nitrates, carbonates, silicates, chlorides and sodium ions; all referred to herein as “wastewater” in the specification and claims. It comprises removing all or a portion of the suspended organic solids and sorbed PPCPs and PFAS in the wastewater with sulfurous acid precipitation and filtration and then exciting pH elevated sulfites with UV for producing a treated disinfected effluent with reduced: solids, N, P, PPCPs, PFAS, and BOD.

Specifically, SO₂ or sulfurous acid is injected into the wastewater via gaseous SO₂ tanks or with a sulfurous acid generator burning prilled refinery sulfur at a pH and dwell time to generate sufficient sulfurous acid with free SO₂, sulfites and bisulfites to:

i. self-agglomerate the colloidal suspended solids,

ii. acid leach heavy metals contained in and on the suspended solids into solution for subsequent removal and separation, and

iii. condition the suspended solids for subsequent chemical dewatering shedding water upon separation and drying without polymers.

By avoiding hydrophilic polymers for coagulation, a much drier bio solid results using sulfurous acid coagulation.

Chemical bio solids drying avoids heat drying usually required as wet bio solids must be dried to less than 20% water before power generation. For example, polymer coagulated sludge typically has 40% water, requiring large drying energy—typically 60% of the fuel value produced; see “Techno-Economic Analysis of Wastewater Biosolids Gasification” by Nick Lumley et al; www.researchgate.net.

The SO₂ treated solids are then placed on drying beds or dewatering equipment to chemically dry to less than 10% water in 24 to 48 hours. This produces a greater than 90% renewable bio solid fuel having approximately 6,000 to 9,000 BTU/lb. without drying heat energy as an energy sink. This dried bio solid has approximately the same fuel value as woodchips and can be readily gasified or combusted as a co-fired fuel.

The chemically dried solids are then gasified or combusted to generate power; avoiding landfill costs and reducing aerobic and anaerobic greenhouse gas emissions.

These chemically dried solids provide 25% more fuel value than anaerobically digested sludge as anaerobic microbes consume half of the higher energy volatiles as they produce biogas methane and carbon dioxide. For example primary dried solids have a BTU value of approximately 9,000 BTU/lb. vs waste activated sludge having a BTU value of approximately 6,500 BTU/b.; see “Renewable Energy Resources: Banking on Bisolids”, by the National Association of Clean Water Agencies (NACWA) Cal. Res. Bur., August 2007, Moller, Rosa Marie, “A brief on Biosolids Options for Biosolids Management”, P. 37.

Gasifiers produce different emissions depending upon the temperature. According to Wikipedia.

“The dehydration or drying process occurs at around 100° C. Typically the resulting steam is mixed into the gas flow and may be involved with subsequent chemical reactions, notably the water-gas reaction if the temperature is sufficiently high.

The pyrolysis (or devolatilization) process occurs at around 200-300° C. Volatiles are released and char is produced, resulting in up to 70% weight loss for coal. The process is dependent on the properties of the carbonaceous material and determines the structure and composition of the char, which will then undergo gasification reactions.

The combustion process occurs as the volatile products and some of the char react with oxygen to primarily form carbon dioxide and small amounts of carbon monoxide, which provides heat for the subsequent gasification reactions. Letting C represent a carbon-containing organic compound, the basic reaction here is C+O2→CO₂

The gasification process occurs as the char reacts with steam and carbon dioxide to produce carbon monoxide and hydrogen, via the reactions C+H₂O→H₂+CO and C+CO2→2CO.

In addition, the reversible gas phase water-gas shift reaction reaches equilibrium very fast at the temperatures in a gasifier. This balances the concentrations of carbon monoxide, steam, carbon dioxide and hydrogen. CO+H₂O↔CO₂+H₂.”

Thus, lower temperature gasifiers produce CO and unburnt carbon for subsequent combustion. Higher temperature plasma gasifiers produce syngas CO and H₂ with the lowest emissions when combusted

Combusting biogas methane thus produces half the power of plasma gasification Syngas combined cycle plants.

Biogas Combustion

CH₄+2O₂→CO₂+2H₂O

Syngas Combustion

CO+H₂+(Cₛₒₗ)+O₂→CO₂+H₂O

Combustion or gasifying chemically dried filtered bio solids not only provides better net energy production, but avoids anaerobic processes producing higher CO₂ equivalent methane, and N₂O greenhouse gases as typical biogas contains 50-75% methane and 25-50% CO₂. It also contains N₂ 0-10%, and H₂S 0-3%. Combustion of biogas therefore releases significantly more greenhouse gases when compared to combustion and gasification of separated dried solids.

For example:

C₆H₁₂O₆+6O₂→6CO₂+6H₂O Aerobic-CO₂,H₂O produced

C₆H₁₂O₆→3CO₂+CH₄(31×CO_{2eq})Anaerobic biogas-Methane+CO₂

CO+H₂+(Cₛₒₗ)+O₂→CO₂+H₂O Syngas Combustion-CO₂,H₂O

This upfront separation/filtration of the influent total suspended bio solids reduces loading 40%, expanding wastewater treatment plant capacity. It also lowers the filtered wastewater nitrogen and phosphorous content approximately 25%. This reduces subsequent wastewater treatment time and energy consumption to remove the remaining wastewater nitrogen and phosphorus, and minimizes anoxic/noxic methane, nitrous oxide greenhouse gas production.

Gasification “Pyrolysis” is the heating of an organic material, such as biomass, in the absence of oxygen. Biomass pyrolysis is usually conducted at or above 500° C., providing enough heat to deconstruct the strong bio-polymers mentioned above. Because no oxygen is present combustion does not occur, rather the biomass thermally decomposes into combustible gases and bio-char. Most of these combustible gases can be condensed into a combustible liquid, called pyrolysis oil (bio-oil), though there are some permanent gases (CO₂, CO, H₂, light hydrocarbons), some of which can be combusted to provide the heat for the process. Thus, pyrolysis of biomass produces three products: liquid bio-oil, solid bio-char and gaseous syngas. The proportion of these products depends on several factors including the composition of the feedstock and process parameters. However, all things being equal, the yield of bio-oil is optimized when the pyrolysis temperature is around 500° C. and the heating rate is high (1000° C./s) fast pyrolysis conditions. Under these conditions, bio-oil yields of 60-70 wt. % of can be achieved from a typical biomass feedstock, with 15-25 wt. % yields of bio-char. The remaining 10-15 wt. % is syngas. Processes that use slower heating rates are called slow pyrolysis and bio-char is usually the major product of such processes. The pyrolysis process can be self-sustained, as combustion of the syngas and a portion of bio-oil or bio-char can provide all the necessary energy to drive the reaction”; see Agricultural Research Center, US Department of Agriculture, “What is Pyrolysis” www.ars.usda.gov/northeast-area/wyndmoor-pa/eastem-regional-research-center/docs/biomass-pyrolysis-research-1/what-is-pyrolysis/publication.

Bio-char, when land applied, adsorbs carbon dioxide, which further reduces atmospheric greenhouse gas emissions.

In addition, improved reclaimed water quality results by upfront suspended solids removal, as these total suspended solids act as a carbon adsorbent sorbing contaminants, such as heavy metals, pharmaceuticals and personal care products (PPCPs) hazardous prions, perfluoroalkyl and polyfluorolkyl substance (PFAS), and pathogens to their substrate. When burned or gasified, these sorbed contaminants and pathogens are then destroyed.

The water quality is further improved by salt balancing to protect plant roots, which osmotically absorb nutrients and are harmed by saline wastewaters. Salt balancing uses sulfurous acid and lime bi-valent ions to repel and leach away from the roots monovalent salts, such as sodium chloride, and retains other needed nitrogen and phosphorous plant nutrients. This allows for raising a wide variety of high value salt sensitive crops without costly membrane filtration.

The liquid fraction is then pH adjusted above pH 9 with lime to precipitate heavy metal hydroxides, calcium phosphate, and metal sulfates for filtration removal before pH adjustment for bioremediation or land application. At this pH, sulfites are the predominant sulfur specie, which when excited with UV forms highly reactive radicals and aqueous electrons at UV 253.7 nm to reductive degrade nitrate to nitrogen gas. This leaves a treated salt balanced treated effluent with negligible N and P without the need for bioremediation.

In addition, the optimal wavelength to effectively inactivate microorganisms is between 250 and 270 nm. Thus, exciting sulfites below UV 300 nm for denitrification, and destruction of many of the PPCPs and PFAS remaining in the liquid filtrate also disinfects the treated effluent to meet open stream discharge requirements.

The present method employing upfront removal and chemical drying of total suspended solids in a wastewater stream for combustion and/or gasification destroys sorbed PPCPs/pathogens/prions. It avoids anaerobic bioremediation greenhouse gas generation while providing a disinfected treated effluent with reduced PPCPs and negligible PFAS, N and P. It also generates increased net power, and leaves an improved treated reclaimed water metal free, land application or stream discharge.

### DESCRIPTION OF THE DRAWINGS

FIG. 1 illustrates the source of greenhouse gas emissions for a typical wastewater treatment plant.

FIG. 2 illustrates the percentages of greenhouse gas emissions from various wastewater treatment plant processes.

FIG. 3 illustrates how suspended solids substrates adsorb PPCPs, pathogens, heavy metals, which are released when the substrate is broken down by microbes.

FIG. 4 illustrates salt balancing with bi-valent ions to repeal and leach away from the roots monovalent salts, retaining needed plant nutrients.

FIG. 5 illustrates the fuel value of anaerobically digested sludge vs. separated primary solids.

FIG. 6 illustrates acid cation agglomeration of colloidal bio solids without polymers.

FIG. 7 illustrates separated bio solids drying energy usage for polymer separated sludges vs. chemically dried separated solids.

FIG. 8 illustrates an example of a flow diagram removing upfront suspended solids with SO₂ for chemical drying, and conditioning the lime adjusted filtrate with UV excited sulfites to reduce N and P without bioremediation.

The patent or application file contains at least one drawing executed in color. Copies of this patent or patent application publication with color drawing(s) will be provided by the Office upon request and payment of the necessary fee.

### DESCRIPTION OF THE ILLUSTRATED EMBODIMENTS

An example of the present invention will be best understood by reference to the drawings. The components, as generally described and illustrated, could be arranged and designed in a wide variety of different configurations. Thus, the description of the embodiments is not intended to limit the scope of the invention, as claimed, but is merely representative of presently preferred embodiments of the invention.

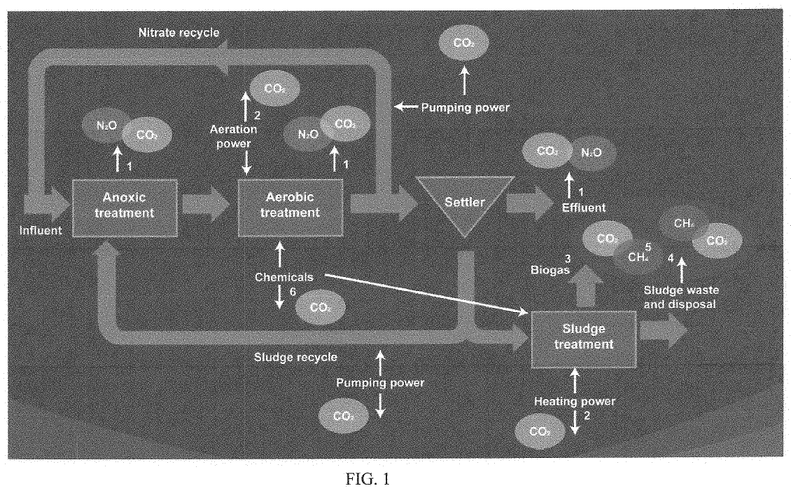

FIG. 1 illustrates the source of greenhouse gas emissions for a typical wastewater treatment plant.

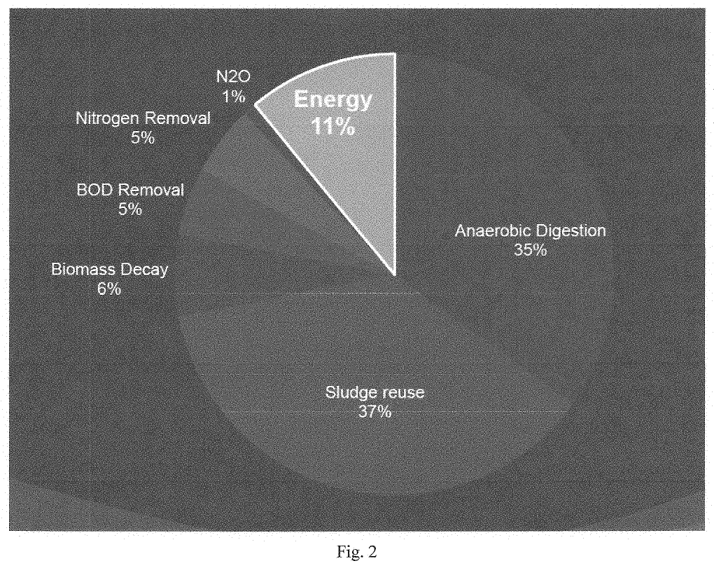

FIG. 2 illustrates the percentages of greenhouse gas emissions from various wastewater treatment plant processes illustrated in FIG. 1. Land application produces 37% of the greenhouse gas emissions followed by anaerobic digestion producing 35% of the greenhouse gas emissions. Gasification/combustion of the upfront separated suspended solids avoids both these processes to significantly reduce greenhouse gas production while generating power.

For example, anaerobic digestion is used to reduce sludge disposal volume to at best 50%. The process generates low BTU biogas releasing methane and CO₂ greenhouse gases, if not captured. Presently 600 wastewater treatment plants in the US flare off this biogas directly to atmosphere, losing any fuel benefit and compounding greenhouse gas emissions. More importantly, this process still requires landfilling of the balance of the sludge resulting in a large footprint as biological processes are slow to degrade these remaining sludges.

Land application decomposition produces CO₂, H₂S, SOx, NOx, CH₄ and H₂O greenhouse gas emissions. It also requires solids drying to reduce the disposal volume and has a long decomposition time in years, continually emitting greenhouse gases to atmosphere, while generating odors.

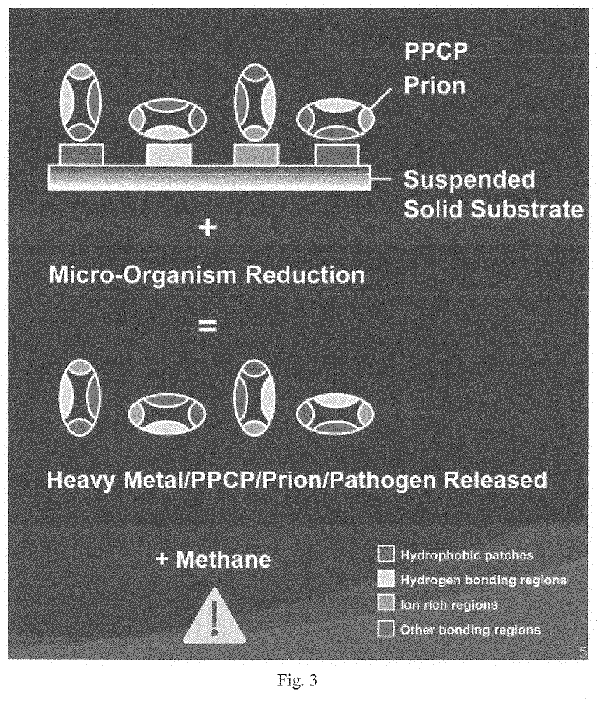

FIG. 3 illustrates how suspended solid substrates adsorb PFAS, PPCPs, pathogens, heavy metals, which are released when the substrate is broken down by microbes. Their upfront removal significantly improves reclaimed water quality and reduces loading on a wastewater treatment plant's bioremediation equipment; thereby expanding its processing capacity. Gasification/Combustion of the separated solids then destroys the sorbed PFAS, PPCPs, prions, pathogens. Heavy metals separately acid washed from the solids substrate are chemically precipitated via lime addition to precipitate metal hydroxides for independent disposal.

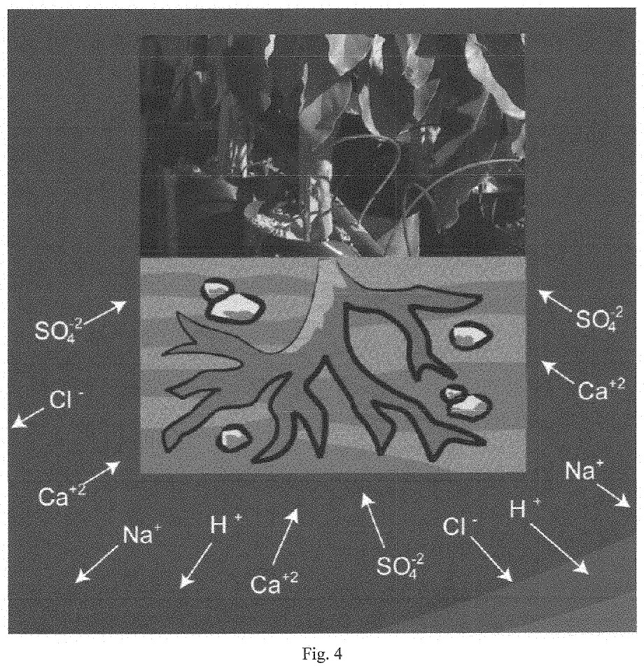

FIG. 4 illustrates salt balancing with bi-valent ions to repeal and leach away from the roots monovalent saline salts, retaining needed plant nutrients.

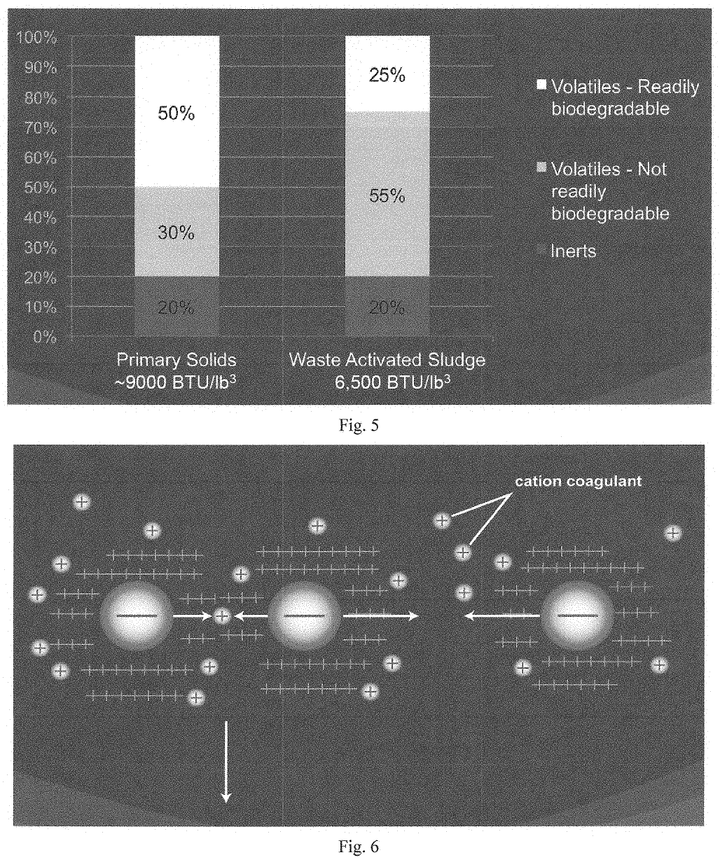

FIG. 5 illustrates the fuel value of anaerobically digested sludge vs. separated primary solids. Separated primary solids have 25% more fuel value than anaerobically digested sludge as the anaerobic microorganisms first consume the high energy volatiles to produce biogas. Thus the fuel value of primary separated solids is approximately 9,000 BTU/lb. compared to waste activated separated sludge having a BTU value of approximately 6,500 BTU/lb.

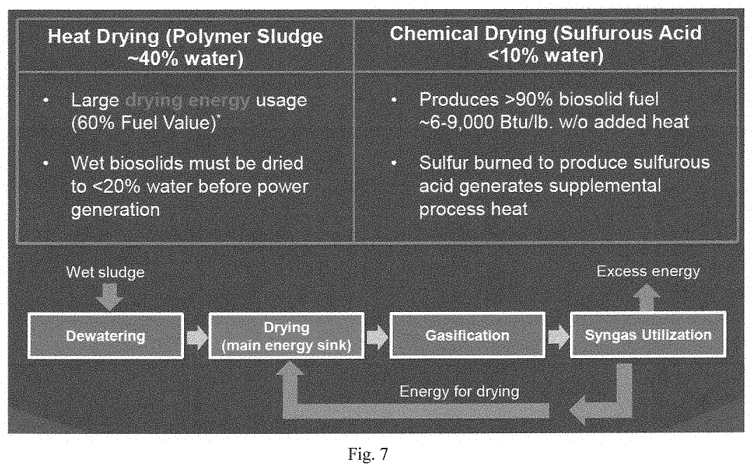

FIG. 6 illustrates acid cation agglomeration of colloidal bio solids without polymers. Suspended solids are negatively charged, and when hydrogen cation acid is added, they readily coagulate for easy separation. As the acid addition avoids hydrophilic polymers, the sulfurous acid chemically dried bio solids contain less than 10% water vs. 40% water of polymer separated solids.

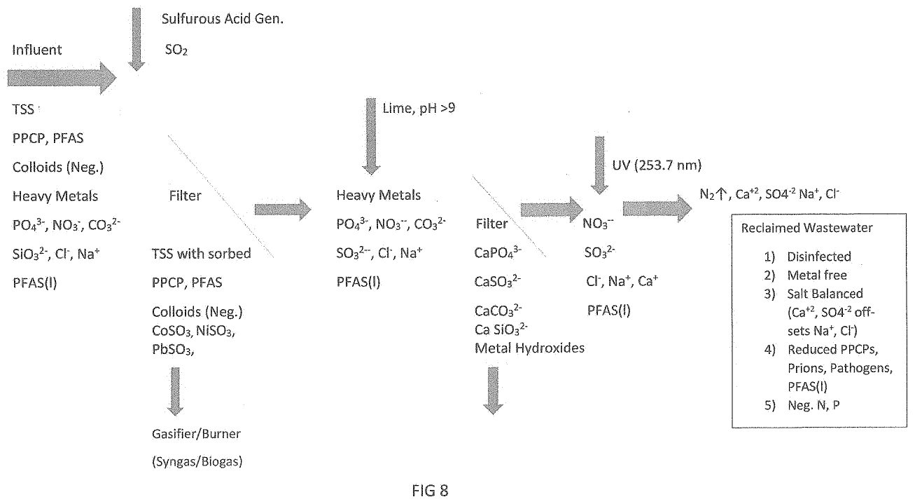

FIG. 7 illustrates separated bio solids drying energy usage for polymer separated sludges vs. chemically dried separated solids. For gasification or combustion, the separated bio solids must be dried to less than 20% water content before power generation. This requires large drying energy usage of polymer separated solids, which constitutes approximately 60% of the fuel value according to “Techno-Economic Analysis of Wastewater Biosolids Gasification” by Nick Lumley et al; ww3.aiche.org/ . . . ?p325428.page 7, supra. Chemically dried separated solids thus generate significantly more fuel value than dried polymer separated fuels.

FIG. 8 illustrates an example of a flow diagram removing upfront suspended organic solids for chemical drying, and conditioning the filtrate as reclaimed water for land or stream application without bioremediation processing. Sulfurous acid at a pH less than 6.5 is added via a sulfurous acid generator to saline wastewater influent with PPCPs, PFAS, colloids, heavy metals, phosphates, nitrates, carbonates, silicates, to precipitate and remove the suspended solids with sorbed PFAS/PPCPs/Prions/Pathogens, which are dried using a drain Pad/Dryer, belt press, etc. for chemical drying without heat. After 24 to 48 hours, the chemically dried solids have less than 10% water and are transferred to a gasifier or combustor, such as a kiln, co-fired boiler, etc. This destroys sorbed PFAS/PPCPs/Prions/Pathogens, while generating more power output with reduced greenhouse gases, as methane and nitrous oxide anaerobic production are avoided.

The filtrate is then lime adjusted in a dwell tank at a pH greater than or equal to 9 for precipitating metal hydroxides, calcium phosphates, calcium sulfites, calcium silicates, and calcium carbonates for separation with a filter or settling tank. At pH 9, this second filtrate is high in nitrates and sulfites and may contain some dissolved PFAS. The second filtrate is exposed to UV 315 nm or below, preferably between 250 and 270 nm, exciting the sulfites to reduce nitrates to nitrogen gas and destroying PFAS leaving a treated reclaimed wastewater which is disinfected, metal free, salt balanced, and has reduced PFAS/PPCPs/Prions/Pathogens and negligible N and P.

This chemical treatment without biological reduction significantly reduces BOD, nitrogen, phosphates, heavy metals, pathogens and other contaminants. It also provides a renewable biofuel for gasification or co-firing with other fuels to destroy sorbed PFAS/PPCPs/Prions and reduce overall greenhouse gas production.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A treatment method for waters containing suspended organic solids, PPCPs, PFAS, negative colloids, heavy metals, phosphates, nitrates, carbonates, silicates, chlorides and sodium ions comprising:
a. adding SO₂ or sulfurous acid with free SO₂, sulfites and bisulfites to the wastewater at a pH and dwell time to:
i. acid leach heavy metals contained in and on the suspended organic solids into the SO₂ or sulfurous acid solution for subsequent removal and separation, and
ii. precipitate the suspended organic solids and sorbed PPCPs, PFAS, and negative colloids, cobalt sulfite, nickel sulfite, and lead sulfite;
b. separating the suspended organic solids and sorbed PPCPs, PFAS, negative colloids, and metal precipitates from the filtrate solutions of SO₂ or sulfurous acid and allowing them to dry to create metal precipitates, and a biofuel with less than 10% by weight water and a BTU content between 6,000 and 9,000 BTU/lb. for gasifying or combustion to produce power or energy with greenhouse gas emissions less than emitted by landfilling and/or anaerobic digestion;
c. adding lime to raise the pH above 9 of the SO₂ or sulfurous acid filtrate solution to precipitate calcium phosphate, calcium sulfate, calcium carbonate, calcium silicate and metal hydroxides for filtration removal leaving a second filtrate with PFAS, PPCPs, pathogens, nitrates, sulfites, chlorides, and sodium and monovalent ions; and
d. exposing the second filtrate to ultra violet light at the wave length and dwell time for pathogen disinfection, and exciting the sulfites to reduce nitrates to nitrogen gas and degrade PFAS, and PPCPs, forming a disinfected metal free salt balanced reclaimed wastewater with degraded PPCPs, PFAS and reduced nitrogen, phosphorous.

2. The treatment method according to claim 1, wherein gasification produced biochar and is land applied to adsorb atmospheric carbon dioxide.

3. A treatment apparatus for waters containing total suspended organic solids, PPCPs, PFAS, negative colloids, heavy metals, phosphates, nitrates, carbonates, silicates, chlorides and/or sodium ions comprising:
a. means for adding SO₂ or sulfurous acid with free SO₂, sulfites and bisulfites to the wastewater at a pH and dwell time to:
i. acid leach heavy metals contained in and on the suspended organic solids into the SO₂ or sulfurous acid solution for subsequent removal and separation, and
ii. precipitate the suspended solids and sorbed PPCPs, PFAS, negative colloids, metal precipitates cobalt sulfite, nickel sulfite, and lead sulfite;
b. means for separating the suspended organic solids and metal precipitates from the solutions of SO₂ or sulfurous acid and allowing the organic solids to dry to create a biofuel with less than 10% by weight water and a BTU content between 6,000 and 9,000 BTU/lb.;
c. means for gasifying or combustion the biofuel to produce power or energy with greenhouse gas emissions less than emitted by landfilling and/or anaerobic digestion;
d. means for adding lime to raise the pH above 9 of the SO₂ or sulfurous acid filtrate solution to precipitate calcium phosphate, calcium sulfate, calcium carbonate, calcium silicate and metal hydroxides for filtration removal leaving a second filtrate with PFAS, PPCPs, nitrates, sulfites, chlorides, and sodium and monovalent ions; and
e. means for exposing the second filtrate to ultra violet light at the wavelength and dwell time for pathogen disinfection, exciting the sulfites to reduce the nitrates to nitrogen gas and degrading PPCPs and PFAS, forming a disinfected metal free salt balanced reclaimed wastewater with reduced PPCPs, PFAS, pathogens and nitrogen and phosphorous.

4. The treatment apparatus according to claim 3, wherein the means for gasifying comprises a gasifier or plasma gasifier, and the means for combustion comprises a co-fired boiler or kiln.

5. The treatment apparatus according to claim 3, wherein the means for adding sulfurous acid comprises a sulfurous acid generator combusting raw sulfur producing SO₂ for injection into wastewater and/or-separated solids.
